(19) United States
(12) Patent Application Publication
(10) Pub. No.: US 2001/0027475 A1
(43) Pub. Date: Oct. 4, 2001

(54) Displaying images and other information

(76) Inventors: Yoel Givol, Brookline, MA (US); Amir Harel, Newton, MA (US); Dimitry Markman, Belmont, MA (US); Yoav Medan, Haifa (IL); Yair Lahave, Ganey Tikva (IL); Alon Neufeld, Ganey Tikva (IL)

Correspondence Address: TESTA, HURWITZ & THIBEAULT, LLP, HIGH STREET TOWER, 125 HIGH STREET, BOSTON, MA, 02110, US

(21) Appl. No.: 09/800,097

(22) Filed: Mar. 5, 2001

Related U.S. Application Data
(60) Provisional application No. 60/189,507, filed on Mar. 15, 2000.

(51) Int. Cl. G06F 15/16

(52) U.S. Cl. 709/204

(57) ABSTRACT

Systems and methods for receiving broadcast video images and other information enable users to receive and view both the broadcast video images and user-selected Internet-obtained video and/or data simultaneously. The broadcast video images and the user-selected Internet-obtained video and/or data can be displayed on a single monitor utilizing picture-in-picture or side-by-side technology and can include a broadcast display and a plurality of other data displays for the Internet-obtained video and/or data.

CROSS REFERENCE TO RELATED CASE

This claims priority to and the benefit of Provisional U.S. Patent Application Ser. No. 60/189,507, filed Mar. 15, 2000, the entirety of which is incorporated herein by reference.

### TECHNICAL FIELD

The invention generally relates to viewing television broadcasts and other information such as user-selected video and/or data.

### BACKGROUND INFORMATION

When retrieving various digital data such as video, audio, text, and images, a user at a client computer generally retrieves the digital data from a storage device or server connected via a network to many client computers. The server downloads the digital data and transmits it to the client computer at the user's request via the network.

With such digital data retrieval there is a delay between the time a user requests the digital data and the time when the server downloads it over the network, and there are bandwidth limitations on data throughput and rate of data transmission. In general, bandwidth is wasted when multiple users request the same digital information, in that the same digital information must be transmitted to multiple client computers.

### SUMMARY OF THE INVENTION

The invention generally relates to systems and methods which enable users to receive and view both live broadcast video images and other information (such as video and/or data) that is obtained from the Internet or, more particularly, the World Wide Web portion of the Internet (the “Web”).

In one aspect, the invention involves a method of distributing a plurality of digital video clips to a plurality of users. The method comprises receiving the plurality of digital video clips from at least one database over a wide area communication network in response to requests from the plurality of users. The plurality of users are in communication with a local area communication network. The method further comprises storing each of the plurality of digital video clips in at least one carousel according to the order in which each of the plurality of digital video clips is received. The at least one carousel is in communication with the wide area communication network and the local area communication network. The method still further comprises transmitting each of the plurality of digital video clips simultaneously to each of the plurality of users over the local area communication network according to the order in which each of the plurality of digital video clips was received.

In one embodiment, the method further comprises processing the requests for the plurality of digital video clips from the plurality of users. In some embodiments, processing the requests eliminating duplicate requests and determining if a requested digital video clip is in the at least one database. In another embodiment, the method further comprises compiling a list of previously requested digital video clips. In still another embodiment, the method further comprises requesting additional digital video clips be sent to the at least one carousel based on the list of previously requested digital video clips. In still other embodiments, the method further comprises storing each of the plurality of digital video clips in a particular one of the at least one carousel based on subject matter of the digital video clip. In still other embodiment, further comprises storing each of the plurality of digital video clips in a particular one of the at least one carousel based on origin of the digital video clip.

In another aspect, the invention involves a system for distributing each of a plurality of digital video clips to each of a plurality of users. The system comprises at least one database for storing each of the plurality of digital video clips. The at least one database is in communication with a wide area communication network. The system further comprises at least one carousel in communication with the wide area communication network and a local area communication network. The carousel comprises a receiving module, a storing module, and a transmitting module. The receiving module receives each of the plurality of digital video clips from the at least one database over the wide area communication network. The storing module stores each of the plurality of digital video clips in the order each of the plurality of digital video clips was received by the receiving module. The transmitting module transmits each of the plurality of digital video clips in the order in which they were received to each of the plurality of users over the local area communication network.

In one embodiment, the system further comprises a processing module for processing requests for the plurality of digital video clips. In some embodiments, the processing module eliminates duplicate requests and determines if a requested digital video clip is in the at least one database. In another embodiment, the system further comprises a user interface for allowing the plurality of users to request, receive, and view each of the plurality of digital video clips transmitted by the transmitting module. In still another embodiment, the system further comprises a profiler for compiling a list of previously requested digital video clips for the plurality of users and for requesting that additional digital video clips be sent to the at least one carousel based on the list of previously requested video clips. In another embodiment, the storing module also stores each of the plurality of digital video clips in a particular one of the at least one carousel based on subject matter of the digital video clips. In still other embodiments, the storing module also stores each of the plurality of digital video clips in a particular one of the at least one carousel based on origin of the digital video clips.

In yet another aspect, the invention involves a method of obtaining digital video clips. The method comprises receiving a live broadcast video feed and associated live data feed. The live broadcast video feed comprises an event clock and live broadcast video images. The live broadcast video images include the associated live data feed which comprises data associated with the live broadcast video images. The method further comprises storing the live broadcast video images as a plurality of digital video clips in a first database along with a plurality of time-stamps. Each of the plurality of time-stamps corresponds to a time when an event in each of the plurality of digital video clips occurred. The time-stamps are obtained from the event clock. The method further comprises storing information about the event in each of the plurality of digital video clips in a second database along with one of the plurality of time-stamps corresponding to the time when the event in the digital video clip occurred. The information about the event in each of the plurality of digital video clips is obtained from the associated live data feed.

In one embodiment, the method further comprises parsing the information stored in the second database to obtain pertinent information and storing the pertinent information in a third database. In some embodiments, the pertinent information is information regarding a sporting event, a news event, and/or a musical event.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1A is an illustrative embodiment of a possible visual display of the present invention.

FIG. 1B is an illustrative embodiment of another possible visual display of the present invention.

FIG. 2A is a schematic illustration of an embodiment of a system according to the invention which is capable of producing the visual displays of FIGS. 1A and 1B and which is configured for cable-based delivery of data and/or video.

FIG. 2B is a schematic illustration of an embodiment of a system according to the invention which is configured for Web-based delivery of data and/or video.

FIG. 3A is an illustrative block diagram of software and hardware components associated with the system of FIG. 2A.

FIG. 3B is an illustrative block diagram of software and hardware components associated with the system of FIG. 2B.

### DESCRIPTION

The invention generally relates to systems and methods which enable users to receive and view both live broadcast video images and other information (such as video and/or data) that is obtained from the Internet or, in one particular embodiment, the World Wide Web portion of the Internet (the “Web”). The live broadcast video images are images that are transmitted (by, for example, a television station by, for example, airwaves, cable, and/or satellite) and received by the user a short time after they are transmitted. (The short delay between transmission and user reception being due to factors such as the processing time required by the transmission and reception equipment, the time it takes for the transmitted signal(s) to travel through and/or within the transmission medium(s), etc.) The event(s) shown in the live broadcast video images could occur contemporaneously (or substantially contemporaneously) with the transmission of the live broadcast video images, or the event(s) shown in the live broadcast video images could have occurred prior to the transmission of the live broadcast video images. For example, a television station could transmit live broadcast video images of a football game in real-time as it is being played. In this example, the user receives the live broadcast video images a short time after they are transmitted, and the event shown in the live broadcast video images (i.e. the football game) occurs at substantially the same time as the transmission of the live broadcast video images. Alternatively, a television station could transmit live broadcast video images of an event that has occurred in the past. For example, a television station could transmit live broadcast video images of a concert a week (or a day or an hour, etc) after the concert actually occurred or started. In this example, the user again receives the live broadcast video images a short time after they are transmitted, but the event shown in the live broadcast video images (i.e. the concert) occurred (or started) a week (or a day or an hour, etc.) prior to the transmission of the live broadcast video images.

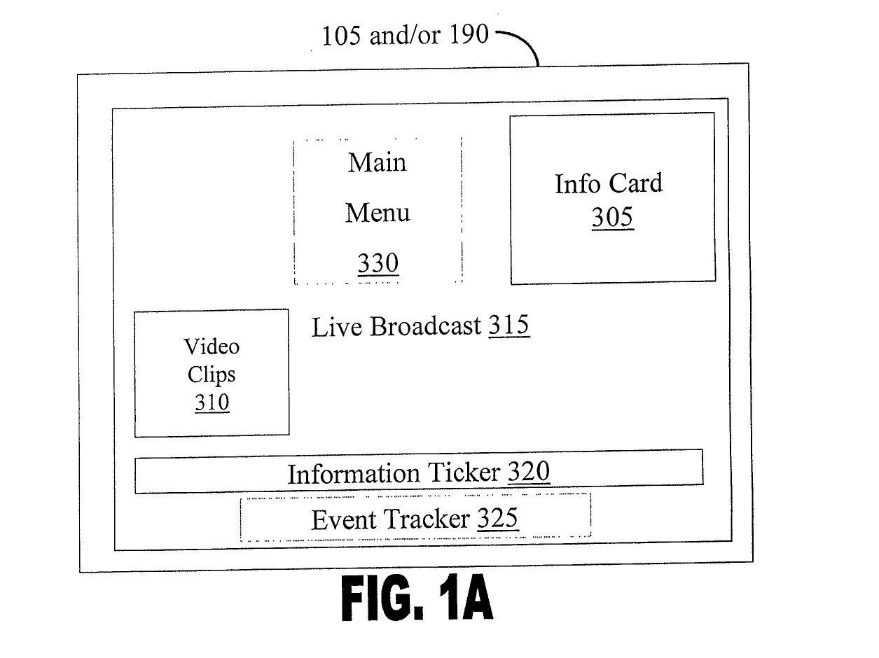

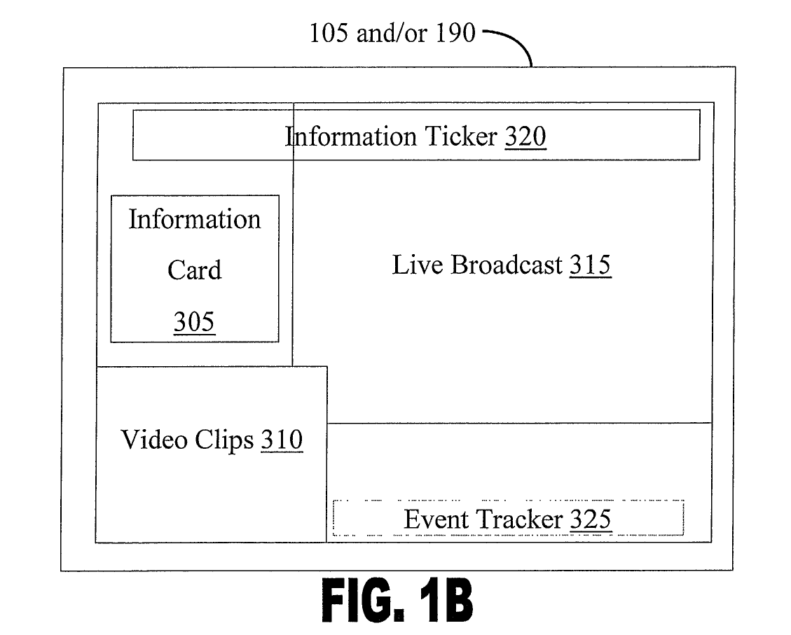

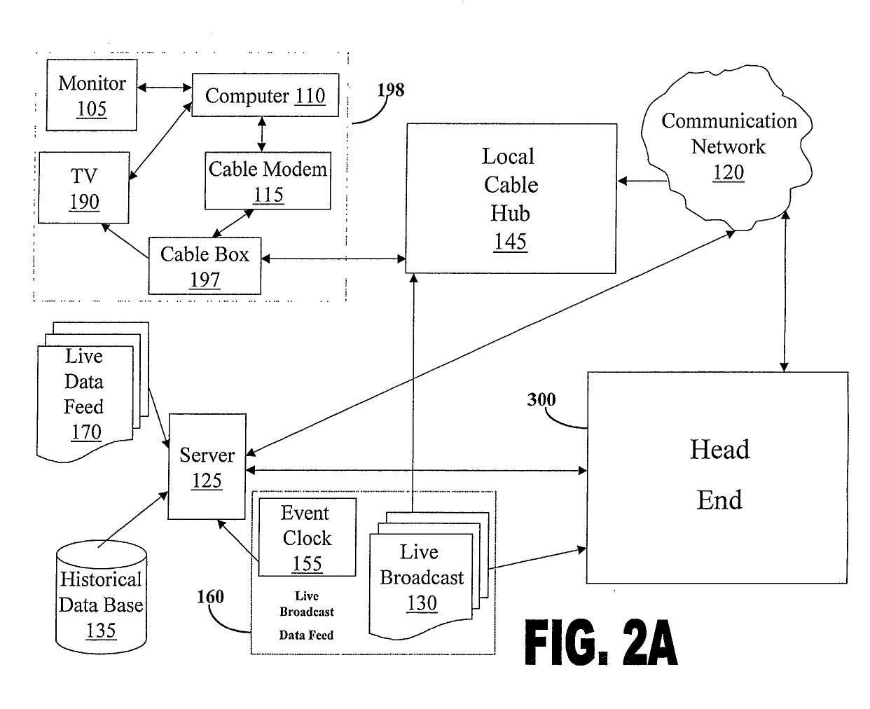

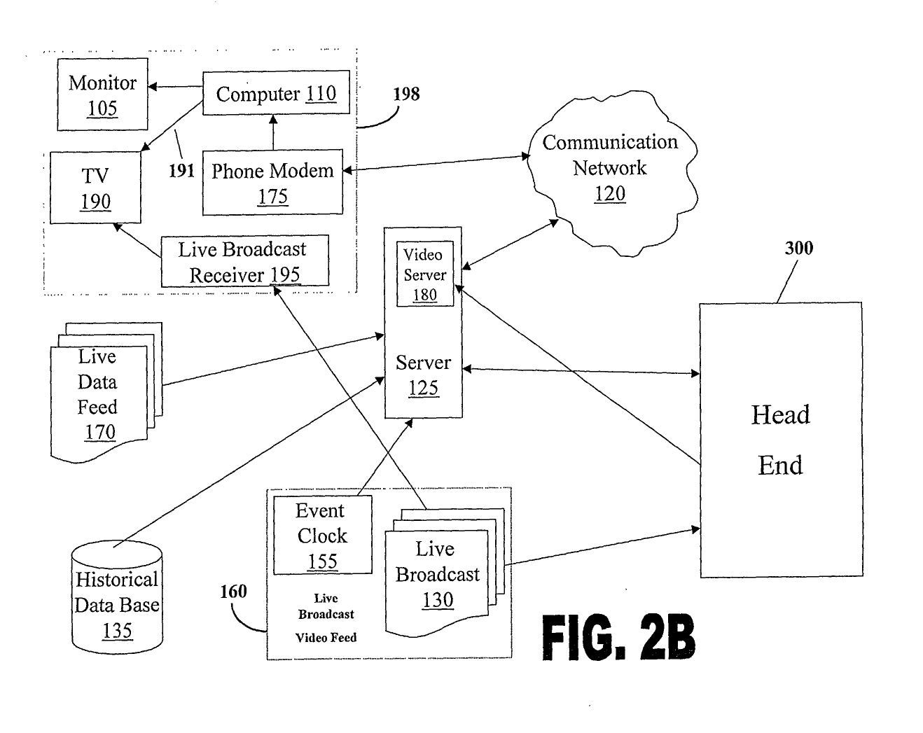

In one embodiment, as shown for example in FIG. 2A, the user is able to view live broadcast video images 130 and Internet-obtained video and/or data simultaneously using a client computer 110, a cable modem 115, and a computer monitor 105. The live broadcast video images 130 and the Internet-obtained video and/or data are received together by the client computer 110, via the cable modem 115, from a local cable company's local cable hub 145. The live broadcast video images 130 are then displayed on the computer monitor 105 and/or a television 190 with the Internet-obtained video and/or data displayed in one or more windows that are overlayed on the live broadcast video images 130 as shown, for example, in FIGS. 1A and 1B.

Referring to FIGS. 1A and 1B, in one embodiment according to the invention, a display (for example, the monitor 105 and/or the television 190) according to the invention can utilize picture-in-picture (PIP) or side-by-side technology and can include a live broadcast display 315 plus a data display or information card 305, a video clips display 310, an information ticker 320, and/or an event trackers 325, and a main menu window 330. A PIP display is a display feature in which one or more small windows are overlayed on a main screen display. A side-by-side display is a display feature in which two or more display windows are positioned next to each other on a view screen or where one window is positioned above the other on the view screen or more generally where any two or more windows are positioned generally near each other on the view screen. The live broadcast display 315 is the actual live broadcast of a television program (such as the live broadcast video images 130 of FIGS. 2A and 2B), such as a football game, for example, and this live broadcast display 315 typically appears in the main viewing area of the computer monitor 105 and/or television 190.

The information card 305 and the information ticker 320 are PIP windows which are overlayed on the live broadcast display 315. The event tracker 325 and the main menu 330 are pop-up windows that appear on the screen overlayed on the live broadcast display 315 and are accessed by using an input device in communication with the computer 110. These input devices can include a mouse, trackball, or keyboard, for example.

The information card 305 and/or the video clips display 310 can be displayed side-by-side with a window displaying the live broadcast 315. The information card 305 can contain user-selected historical or recent data, such as the number of yards run by a particular football player in a previous football season or the number of yards run by a particular football player in the current game, for example. This data can appear in one or more of any number of display formats, such as lists, pie charts, graphs, etc. The information ticker 320 is a scrolling list of current data relating to the live broadcast 315 or some other current event. The event tracker 325 is a pop-up list of user requested historical and/or recent video clips available for display in the video clip display 310. The video clip playing in the video clips display 310 can be changed by accessing the event tracker 325 and clicking (with a mouse or trackball, for example) on any of the listed video clips. As previously stated, the main menu 330 is a pop-up window and is used to configure the appearance of the various windows, set user options, select and/or request historical or recent video clips and select and/or request historical or recent data.

In another embodiment, as shown for example in FIG. 2B, a phone modem 175 is used in place of the cable modem 115. The Internet-obtained video and/or data is received by the client computer 110, via the phone modem 175, from a communication network 120 (e.g., the Web) and displayed in the overlay windows on the computer monitor 105. The live broadcast video images 130 are received by a live broadcast video image receiver 195 and displayed on a separate computer monitor 105 or the television 190. It is also possible with this embodiment (FIG. 2B) to connect the client computer 110 to the television 190 to achieve simultaneous display on the monitor 105 and/or the television 190 as shown in FIGS. 1A and 1B.

Referring again to FIG. 2A, in one embodiment, a system of the invention for receiving and viewing both live broadcast video images 130 and Internet-obtained video and/or data is configured for receiving cable-based data and video. At the user's end 198, the system includes at least one computer monitor 105 (monitor) and client computer 110, a cable box 197, a cable modem 115, and a television 190. In addition to the components included at the user's end 198, this configuration typically includes a local cable company's local cable hub 145 (local cable hub), a wide area communication network 120, such as the Internet or the Web, a server computer 125, a historical database 135, a head end 300, and a live broadcast data feed 160. The live broadcast data feed 160 includes live broadcast video images 130 and an event clock 155.

At the user's end 198, the cable box 197 receives the live broadcast video images 130 and Internet-obtained video and/or data in one data stream from the local cable hub 145 (which is in communication with the wide area communication network 120). The cable box 197 delivers the live broadcast video images 130 to the television 190 (through a television cable-in port) and delivers the live broadcast video images 130 and Internet-obtained video and/or data to the cable modem 115. The cable modem 115 transmits the live broadcast video images 130 and the Internet-obtained video and/or data to the client computer 110. The client computer 110 transmits the live broadcast video images 130 and the Internet-obtained video and/or data to the monitor 105 or the television 190 (through a video-in or auxiliary input port) for display. User interface software resident on the client computer 110 allows the user to control how and what data is displayed. The data that can be displayed includes, but is not limited to, live broadcast video, statistical data, streaming video, and scrolling tickers.

The local cable hub 145 receives Internet-obtained video and/or data via the communication network 120, and generally also receives the live broadcast video images 130 from the cable company's main transmitter.

The server computer 125 is in communication with the communication network 120, the historical database 135, a live data feed 170, and the Head End 300. The server computer 125 also receives the event clock 155.

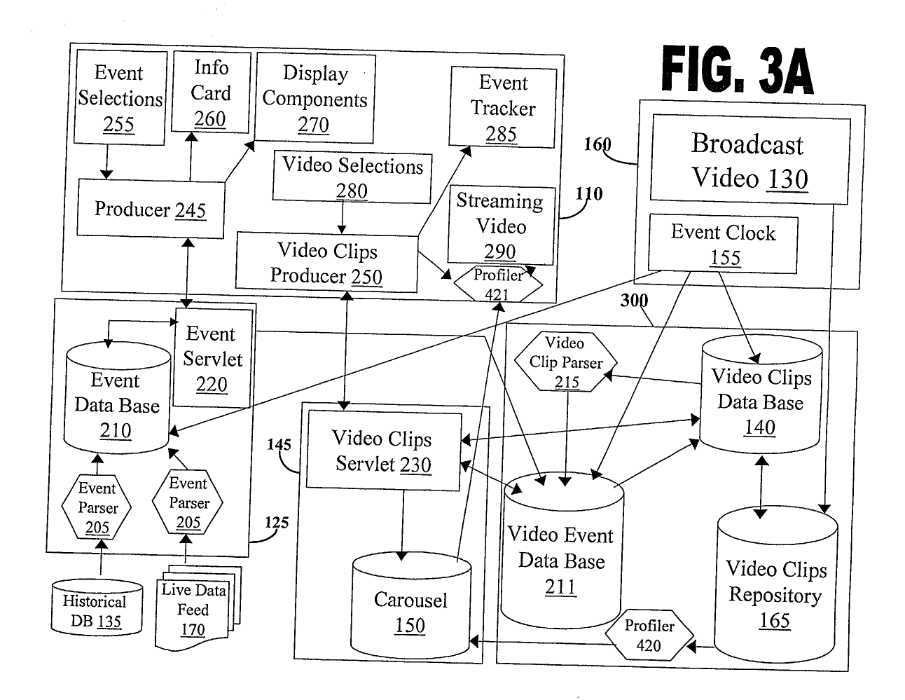

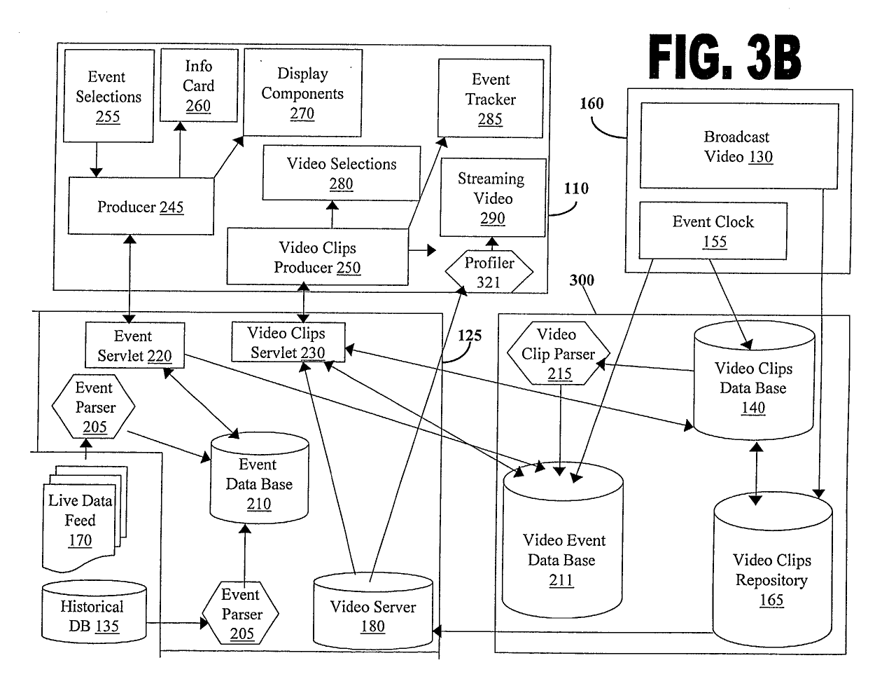

The software and hardware components of the cable-based embodiment of the invention can be configured as shown in FIG. 3A. In this configuration, both live broadcast video images 130 and Internet-obtained video and/or data are received by the client computer 110 via the cable modem 115 and displayed simultaneously on the computer monitor 105 and/or television 190.

The user interface software resides on the client computer 110 and allows the user to configure the PIP windows and enables the user to select the data and video displayed in each PIP or side-by-side window. In one embodiment, this user interface software is a plug-in component for a communication network browser such as NETSCAPE NAVIGATOR, for example. The user interface software comprises several modules including an event selection module 255, an information card module 260, a display components module 270, a producer module 245, a video selections module 280, an event tracker module 285, a video clips producer module 250, and a streaming video module 240.

The event selection module 255 is accessed through the main menu 330 and allows the user to request specific historical or recent data to be displayed in the information card 305. The producer module 245 transmits (over the communication network 120) user requests for specific data to the event servlet 220 (which resides on the server 125) using a TCP/IP or other communication protocol. The producer module 245 also receives the user-requested data from the event servlet 220 (over the communication network 120) and stores the requested data in a local cache or mass storage device. The producer module 245 then transfers a notice of requested data arrival to the information card module 260. The information card module 260 displays, in the information ticker 320, a scrolling list user requested historical and/or recent data. Similarly, the user can instruct the event selection module 255 through the main menu 330 to request historical or recent data to be displayed in the information card 305. The producer module 245 also transfers the requested data to the display components module 270. The display components module 270 receives data from the producer module 245 and displays it in the information card 305 in various forms including, but not limited to, tables, lists, graphs, and pie charts. The information card 305 may appear as a window overlayed on the live broadcast 315 or as window side-by-side another window displaying the live broadcast 315.

The video selection module 280 is accessed through the main menu 330 and allows the user to request specific historical or recent video clips to be played in the video clips display 310. The video clips producer module 250 transmits (over the communication network 120) user requests for specific video clips to the video clips servlet 230 (which resides on the cable hub 145). Additionally, the video clips producer module 250 receives (over the communication network 120) video clip characterization data from the video clip servlet 230 and transfers the video clip characterization data to the event tracker 325. Video clip characterization data includes information regarding content of the video clip. The streaming video module 290 receives the requested video clips from a carousel 150 located in the local cable hub 145 (discussed below) and stores them in the local cache or mass storage device. When the requested video clip is retrieved from the carousel 150, the event tracker 325 appears on the monitor 105 or television 190 to inform the user that the requested video clip has been successfully retrieved. The user may then select the requested video clip to be played by clicking on the event tracker 325. The video clips producer 250 then instructs the streaming video module 290 to retrieve the requested video clip and plays the video clip in the video clips display 310.

In one embodiment, once the user selects a clip for viewing, the monitor 105 or television 190 will split into two windows, a larger window, and a smaller window. The larger window will display the current live broadcast 315, while the smaller window will contain a progress clock indicating that the selected video clip is being loaded. The clip will load and the first frame of the clip will be displayed “frozen” in the video clips display 310 (the smaller window). The user must then click on the “frozen” clip to begin playing the clip. When the clip starts it will switch to the larger window and the live broadcast 315 will be displayed in the smaller window. After the clip has finished playing, the last “frozen” frame will switch back to the smaller window and the live broadcast 315 will switch to the larger window. The user can rerun the video clip by clicking on the last “frozen” frame. In other embodiments, viewing controls (play, stop, pause, fast forward, rewind, etc) will also appear with the video clips display 310 which will allow the use to manipulate the video clip. After a predetermined time of inaction, the video clips display 310 window will disappear and the live broadcast 315 will return to full screen view.

In another embodiment, the event tracker 325 can be recalled to the screen using the main menu 330 or clicking a different mouse button. In this embodiment, the event tracker 325 includes the last five requested video clips, any of which can be replayed by clicking on the particular video clip.

In another embodiment, the user interface software resident on the client computer 110 includes a profiler module 421. This module receives video clips transmitted from the carousel 150 and before transmitting them to the streaming video module 290 compares video clip characterization data from the video clips producer 250 to a stored user profile for the current user to determine if the video clip received is one of the video clips requested. If the received video clip characterization data matches the current user profile, the video clip is transmitted to the streaming video module 290. If the received video clip characterization data does not match the current user profile, video clip is discarded.

The software that is used to receive and process user requests for data resides on the server 125 and includes an event servlet 220, event parsers 205 and an event database 210. The software that is used to receive and process user requests for video resides on the local cable hub 145 and the head end 300. The software on the local cable hub 145 includes a video clips servlet 230 and a carousel 150. The software on the head end 300 includes a video clips parser 215, a video clips database 140, a video clips repository 165, a video event database 211, and a profiler 420.

Looking now at the server 125, the live data feed 170 comprises information relating to events that are currently happening, such as a football game currently being played. The data from the historical database 135 comprises information relating to events that have previously occurred, such as a football game from yesterday or last year, for example. The live data feed 170 and the historical data from the historical database 135 are received by the server 125 and passed through event parsers 205. Each event parser 205 removes irrelevant information and stores the pertinent live and historical data in the event database 210 in dynamic tables. In some embodiments, the pertinent data includes information regarding sporting events, news events, and/or musical events. For example, during a football game, the pertinent information includes the actual game and updates of other games, while the irrelevant information includes commercials, half-time entertainment, and news briefs. The live data, as it is stored in the event database 210, is synchronized to the event clock 155. The event clock 155 corresponds to the elapsed time in the particular program currently being viewed. For example, if the program currently being viewed is a football game where thirty minutes of the game have been played, the event clock would indicate thirty minutes of elapsed time since the start of the game.

Looking now at the cable hub 145 and head end 300, the video clips repository 165 receives and stores live broadcast video images 130 as video clips. As the live broadcast video images 130 are stored in the video clips repository 165, the video clips database 140 stores information regarding the video clips along with the time the video clip occurred (as determined by the event clock 155) and time-stamps the video clip stored in the video clips repository 165 with the time the video clip actually occurred. As the video clips records are stored in the video clips database 140, the event servlet 220 retrieves pertinent data from the event database 210 and sends this data to the video event database 211. The data received from the event database 210 is used to determine which clips stored in the video clips database 140 are useful. These useful clips are passed through the video clip parser 215 so that irrelevant information can be removed. The remaining pertinent video clip characterization data is then stored in the video clip event database 211. Thus, characterizing information about the video clips in the video clip repository 165, including the time the live images occurred, is stored in the video event database 211.

The final result is that the event database 210 stores both live (or recently acquired) and historical data, where the live data comprises information about an event which is synchronized to video data of that event that is stored in the video clips repository 165.

The event servlet 220 is used to process requests for live and/or historical data and retrieve such data from the event database 210 and transmit the data to the producer 245 of the requesting client computer 110. The video clip servlet 230 is used to process requests for live and/or historical video data. The video clip servlet 230 retrieves video clip characterization information from the video event database 211 and transmits the video clip characterization information to the video clips producer 250 of the requesting client 110. The video clip servlet 230 also instructs the video clips database 140 to have the video clips repository 165 transmit the requested video clips to the carousel 150 at the local cable hub 145.

The carousel 150 is located at the local cable hub 145 of an area cable company and is capable of providing video clips to all the users with cable modems 115 serviced by that local cable hub 145 (all the users connected to the cable hub local area network). Each separate local cable hub 145 of an area cable company will have a separate carousel 150. The carousel 150, in one embodiment, stores three hundred video clips, with each video clip lasting five seconds. Each video clip in the carousel 150 is available to be retrieved by a user once per minute. In one embodiment, the carousel 150 acts as a first-in-first-out storage device. The video clips are stored in the carousel 150 in the order in which the video clips are received. Likewise, the video clips are transmitted to users in the order in which the video clips are received.

The purpose of the carousel 150 is to allow individual video clips that are requested by multiple users to be downloaded to the carousel 150 once and transmitted to all the users who request the video clip at the same time. This process of simultaneous transmission to multiple users is called multi-casting. For example, one hundred users request video clips of every penalty committed by a particular player in the current game. Instead of downloading one hundred copies the requested video clip and transmitting them to the requesting users, only one copy of the requested video clip is downloaded to the carousel 150 and then multi-cast to all one hundred requesting users. The result is increased storage space in the carousel 150 for a wider variety of video clips. In addition, since only one copy (instead of one hundred copies) of the requested video clip has to be retrieved over the Internet from the video clip repository 165, the download time is significantly reduced. The video clips that are retrieved from the video clips repository 165 and stored in the carousel 150 can be requested by users as they watch the particular program or the video clips can be requested in advance via user lists submitted to the Head End 300. These user created lists of requested video clips are created with the video selection module 280 and submitted to the video clips producer 250. The video clips producer 250, in turn, transmits the user created lists to the video clips servlet 230 which holds the list for processing until the requested video clips become available. This user created list can also be emailed and shared with other users.

In another embodiment, the head end 300 also includes a profiler 420. The profiler 420 is used to compile a list or profile of desired video clips based on the historical requests of the users in a particular neighborhood serviced by a particular local cable hub 145. The profiler 420 uses the profile to anticipate what video clips will most likely be requested by users serviced by the particular local cable hub 145 and sends the video clips to the carousel 150 as soon as they are available without waiting for actual user requests. The profile for each neighborhood is constantly updated and changes depending on the requests of the users.

During the course of a television program, the carousel 150 is constantly being updated with video clips that are requested by users while watching a particular program or with video clips that are listed in the neighborhood profile. The carousel 150 is also updated with video clips that are updates to previous requests. In the event that the number of unique video clip requests exceeds the number of positions in the carousel 150, the carousel 150 can be expanded by offering three hundred video clips that are five seconds in duration each in a first minute and offering three hundred different video clips that are five seconds in duration each in a second minute. Thus, each of the six hundred different video clips that are five seconds in duration each can be offered every two minutes. In another embodiment, the local cable hub 145 can include multiple carousels 150. For example, there can be one carousel 150 providing video clips for each currently televised sport or one carousel 150 for each television channel broadcasting a sporting event.

The requested video clips are transmitted from the carousel 150 to the streaming video module 290 residing on requesting user's client computer 110 in MPEG2 or other video compression format. In other embodiments, the user interface software on the user's client computer 110 can be configured to permanently store and play the requested video clip immediately after download from the carousel 150 or play the requested video clip without storing it.

In other embodiments, some of the video clips received by users could carry promotional information and/or advertisements. These promotional and/or advertising video clips can be targeted to specific users based on demographics determined by the specific user's viewing habits.

In still other embodiments of the user end 198, the function of the client computer 110, cable modem 115, and cable box 197 could be combined into a single programmable cable box or set top (STB) box that is designed and configured to support and execute the user interface software of the present invention. A hand-held remote control would be used to configure the PIP or side-by-side windows and to request, select, and display Internet obtained video and/or data.

Referring again to FIG. 2B, another disclosed embodiment is one in which the Internet-obtained video and/or data is not delivered to the end user via cable. In this other embodiment, a system of the invention comprises at least one monitor 105 and client computer 110, a phone modem 175 (or an ISDN line and associated ISDN modem, DSL line and associated DSL modem, or T1 connection and associated T1 modem), a television 190, and a live broadcast video image receiver 195 at the user's end 198. In addition to the components at the user's end 198, this configuration comprises a wide area communication network 120, such as the Internet or the Web, a server computer 125, a historical database 135, a live broadcast data feed 160, and a head end 300. The live broadcast data feed 160 includes live broadcast video images 130 and an event clock 155.

At the user's end 198, the phone modem 175 receives the video and/or data through a connection with the communication network 120. The live broadcast video images are received by the live broadcast video image receiver 195 (which can be a satellite dish, rooftop antenna, standard cable, etc.) and transmitted to, and displayed on, the television 190. The phone modem 175 transmits the Internet-obtained video and/or data to the client computer 110, which in turn transmits the Internet-obtained video and/or data to the monitor 105. The user interface software resident on the client computer 110 allows the user to control how and what Internet-obtained video and/or data is displayed on the monitor 105. In this configuration, live broadcast video images and Internet-obtained video and/or data typically are not simultaneously displayed on the monitor 105 or television 190, although it is possible to connect the client computer 110 to the television 190 (illustrated by arrow 191 in FIG. 2B) to achieve simultaneous display on the monitor 105 and/or the television 190 as illustrated in FIGS. 1A & 1B. The Internet-obtained video and/or data can be, for example, statistical data, streaming video, and scrolling tickers.

The server computer 125 is in communication with the communication network 120, the historical database 135, the live data feed 170, and the head end 300. The server computer 125 also receives the event clock 155.

The software and hardware components of the embodiment shown in FIG. 2B can be configured as shown in FIG. 3B. In this configuration, the live broadcast video images are received via standard cable (no cable modem), satellite dish, or rooftop antenna, for example, and are displayed on a television screen 190. The Internet-obtained video and/or data is received by the client computer 110 via the phone modem 175 (or ISDN line and associated ISDN modem, DSL line and associated DSL modem, or T1 connection and associated T1 modem, etc.) and displayed on the computer monitor 105. In one embodiment of this configuration the PIP and side-by-side windows described above are displayed on the computer monitor 105 without the live broadcast video images 130 displayed in the live broadcast display 315.

In this configuration, since the Internet access is not through cable, there is no carousel 150. Instead, video clips are transmitted to the client computer 110 from a video server 180 on the server 125. When video clips are requested by the user via the video selection module 280, the request is taken by the video clips producer 250 and transmitted to the video clips servlet 230 on the server 125. The video clips servlet 230 retrieves video clip characterization information from the video event database 211 and transmits this characterization information to the video clips producer 250 on the client computer 110 which, in turn, transfers the video clip characterization information to the event tracker module 285. The event tracker module 285 displays, in the event tracker 325, a list of user requested historical and/or recent video clips that are available for display in the video clip display 310. The video clips servlet 230 also instructs the video clips database 140 to have the video clips repository 165 transmit the requested video clips to the video server 180. The video clips servlet 230 then instructs the video server 180 to transmit the requested video clips to the streaming video module 290. The streaming video module 290 receives the requested video clips from the video server 180 and stores them in the local cache or mass storage device. The user selects, from the event tracker 325, the requested video clip to be played. The video clips producer 250 then instructs the streaming video module 290 to retrieve the requested video clip and play the clip in the video clips display 310.

In another embodiment, the user interface software resident on the client computer 110 includes a profiler module 421. This module receives video clips transmitted from the video server 180 and, before transmitting them to the streaming video module 290, compares video clip characterization data from the video clips producer 250 to a stored user profile for the current user to determine if the video clip received is one of the video clips requested. If the received video clip characterization data matches the current user profile, the video clip is transmitted to the streaming video module 290. If the received video clip characterization data does not match the current user profile, video clip is discarded.

This configuration (FIGS. 2B and 3B) typically will not have the multi-cast functionality of the cable-based configuration (FIGS. 2A and 3A). Additionally, because the Internet-obtained video and/or data is received via a different source than the live broadcast video images 130, the Internet-obtained video and/or data that is displayed on the computer monitor 105 typically may lag some (small) amount of time behind the live broadcast video images 130 displayed on the television 190. In the Web-based configuration (FIGS. 2B and 3B), the PIP or side-by-side display on the computer monitor 105 can include a window indicating the time differential between the Internet-obtained video and/or data and the live broadcast video images 130.

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A method of distributing a plurality of digital video clips to a plurality of users, comprising:
receiving the plurality of digital video clips from at least one database over a wide area communication network in response to requests from the plurality of users, the plurality of users being in communication with a local area communication network;
storing each of the plurality of digital video clips in at least one carousel according to the order in which each of the plurality of digital video clips is received, the at least one carousel being in communication with the wide area communication network and the local area communication network; and
transmitting each of the plurality of digital video clips simultaneously to each of the plurality of users over the local area communication network according to the order in which each of the plurality of digital video clips was received.

2. The method of claim 1 further comprising the step of processing the requests for the plurality of digital video clips from the plurality of users.

3. The method of claim 2 wherein the step of processing the requests comprises eliminating duplicate requests.

4. The method of claim 2 wherein the step of processing the requests comprises determining if a requested digital video clip is in the at least one database.

5. The method of claim 1 further comprising the step of compiling a list of previously requested digital video clips.

6. The method of claim 5 further comprising requesting additional digital video clips be sent to the at least one carousel based on the list of previously requested digital video clips.

7. The method of claim 1 further comprising storing each of the plurality of digital video clips in a particular one of the at least one carousel based on subject matter of the digital video clip.

8. The method of claim 1 further comprising storing each of the plurality of digital video clips in a particular one of the at least one carousel based on origin of the digital video clip.

9. A system for distributing each of a plurality of digital video clips to each of a plurality of users, comprising:
at least one database storing each of the plurality of digital video clips, the at least one database in communication with a wide area communication network; and
at least one carousel in communication with the wide area communication network and a local area communication network, the carousel comprising:
a receiving module for receiving each of the plurality of digital video clips from the at least one database over the wide area communication network,
a storing module for storing each of the plurality of digital video clips in the order each of the plurality of digital video clips is received by the receiving module, and
a transmitting module for transmitting each of the plurality of digital video clips in the order in which they were received to each of the plurality of users over the local area communication network.

10. The system of claim 9 further comprising a processing module for processing requests for the plurality of digital video clips.

11. The method of claim 10 wherein the processing module eliminates duplicate requests.

12. The method of claim 10 wherein the processing module determines if a requested digital video clip is in the at least one database.

13. The system of claim 9 further comprising a user interface for allowing the plurality of users to request, receive, and view each of the plurality of digital video clips transmitted by the transmitting module.

14. The system of claim 9 further comprising a profiler for compiling a list of previously requested digital video clips and requesting additional digital video clips be sent to the at least one carousel based on the list of previously requested video clips.

15. The system of claim 9 wherein the storing module also stores each of the plurality of digital video clips in a particular one of the at least one carousel based on subject matter of the digital video clip.

16. The system of claim 9 wherein the storing module also stores each of the plurality of digital video clips in a particular one of the at least one carousel based on origin of the digital video clip.

17. A method of obtaining digital video clips, comprising:
receiving a live broadcast video feed and associated live data feed, the live broadcast video feed comprising an event clock and live broadcast video images including, the associated live data feed comprising data associated with the live broadcast video images;
storing the live broadcast video images as a plurality of digital video clips in a first database along with a plurality of time-stamps, each of the plurality of time-stamps corresponding to a time when an event in each of the plurality of digital video clips occurred, the time-stamps being obtained from the event clock; and
storing information about the event in each of the plurality of digital video clips in a second database along with one of the plurality of time-stamps corresponding to the time when the event in the video clip occurred, the information being obtained from the associated live data feed.

18. The method of claim 17 further comprising parsing the information stored in the second database to obtain pertinent information and storing the pertinent information in a third database.

19. The method of claim 18 wherein the pertinent information includes information regarding a sporting event.

20. The method of claim 17 wherein the pertinent information includes information regarding a news event.

21. The method of claim 17 wherein the pertinent information includes information regarding a musical event.
